(19) United States
(12) Patent Application Publication
(10) Pub. No.: US 2026/0005429 A1
(43) Pub. Date: Jan. 1, 2026

(54) Circularly Polarized Antennas And Wearable Devices

(71) Applicant: Anhui Huami Health Technology Co., Ltd., Hefei (CN)

(72) Inventors: Anping Zhao, Hefei (CN); Jiayu Li, Hefei (CN); Pengfei Xu, Hefei (CN)

(21) Appl. No.: 19/310,394

(22) Filed: Aug. 26, 2025

Related U.S. Application Data
(63) Continuation of application No. PCT/CN2024/081802, filed on Mar. 15, 2024.

(30) Foreign Application Priority Data
Mar. 15, 2023 (CN) 202310267464.8

(51) Int. Cl. H01Q 1/27; H01Q 7/00; H01Q 15/24

(52) U.S. Cl. CPC H01Q 1/273; H01Q 7/00; H01Q 15/24

(57) ABSTRACT

Provided are a circularly polarized antenna and a wearable device. The circularly polarized antenna includes a circuit board, an annular radiator arranged at a distance from the circuit board, and a coupling excitation unit, where the coupling excitation unit is arranged in proximity to the annular radiator and electromagnetically coupled to the annular radiator. The coupling excitation unit includes a first coupling branch and a first tuning element, a first end of the first coupling branch being electrically connected to a feeding portion of the circuit board, and a second end of the first coupling branch being electrically connected to a reference ground of the circuit board via the first tuning element. An annular current loop is formed between the coupling excitation unit and the circuit board.

### CROSS-REFERENCE TO RELATED APPLICATION(S)

This application is a continuation of International Application No. PCT/CN2024/081802, filed on Mar. 15, 2024, which claims priority to Chinese Application No. 202310267464.8, filed on Mar. 15, 2023, the entire disclosures of both of which are hereby incorporated by reference.

### TECHNICAL FIELD

The present disclosure relates to the technical field of electronic devices, and specifically to a circularly polarized antenna and a wearable device.

### BACKGROUND

With the development of smart wearable devices, satellite positioning has become one of their most critical functions. To enable satellite positioning and trajectory recording, a satellite positioning antenna is important. To enhance the transmission efficiency from the satellite to the ground, such as improving penetration capability and coverage area, satellite-to-ground transmitting antennas generally employ right-handed circular polarization. Similarly, to enhance reception capability of a positioning antenna, receiving antennas of electronic devices may also adopt right-handed circular polarization similar to that of the satellite-to-ground transmitting antenna.

However, smart wearable devices are constrained by their sizes or industrial designs, making it difficult to realize circularly polarized antennas. Instead, linearly polarized antennas are commonly used in the wearable devices, leading to poor satellite positioning performance of the wearable devices. Compared to traditional linearly polarized receiving antennas, circularly polarized antennas can not only double the intensity of the received satellite signals, but can also effectively minimize multipath interference generated by tall buildings and the ground, thus enabling accurate positioning.

In addition, although there have been some designs that use coupling excitation units to feed annular metallic radiators of smart watches and realize circularly polarized antennas, these designs have major drawbacks or shortcomings. For example, these designs often impose strict requirements on the dimensions of the coupling structure, which cannot be applied to watches of different sizes.

### SUMMARY

To enhance antenna performance of wearable devices and overcome the above-mentioned challenges, the embodiments of the present disclosure provide a circularly polarized antenna and a wearable device incorporating the same.

In some aspects, the techniques described herein relate to a circularly polarized antenna applied to a wearable device, including: a circuit board, an annular radiator arranged at a distance from the circuit board; and a coupling excitation unit arranged in proximity to the annular radiator and electromagnetically coupled to the annular radiator, wherein the coupling excitation unit includes a first coupling branch, a first end of the first coupling branch being electrically connected to a feeding portion of the circuit board; the coupling excitation unit further includes a first tuning element, a first end of the first tuning element being electrically connected to a second end of the first coupling branch, a second end of the first tuning element being electrically connected to a reference ground of the circuit board, and the first tuning element being configured for tuning a resonant frequency of the circularly polarized antenna; and an annular current loop is formed between the coupling excitation unit and the circuit board.

In some implementations, the techniques described herein relate to a circularly polarized antenna, wherein the coupling excitation unit further includes at least one extension branch extending outward from at least one of the first end or the second end of the first coupling branch, the at least one extension branch being configured for further tuning the resonant frequency of the circularly polarized antenna.

In some implementations, the techniques described herein relate to a circularly polarized antenna, wherein the coupling excitation unit further includes a second tuning element, the at least one extension branch being electrically connected to the reference ground of the circuit board via the second tuning element, and the second tuning element being configured for further tuning the resonant frequency of the circularly polarized antenna.

In some implementations, the techniques described herein relate to a circularly polarized antenna, wherein the coupling excitation unit further includes a second coupling branch and a third tuning element, a first end of the second coupling branch sharing a common feeding point with the first end of the first coupling branch, and a second end of the second coupling branch being electrically connected to the reference ground of the circuit board via the third tuning element.

In some implementations, the techniques described herein relate to a circularly polarized antenna, wherein the coupling excitation unit further includes a second coupling branch, the first coupling branch is configured for electromagnetically coupling with the annular radiator to generate a resonant signal at a first target frequency, and the second coupling branch is configured for electromagnetically coupling with the annular radiator to generate a resonant signal at a second target frequency.

In some implementations, the circularly polarized antenna further includes at least one filter unit, the at least one filter unit being electrically connected to a connection circuit between at least one of the first coupling branch or the second coupling branch, and the reference ground of the circuit board.

In some implementations, the techniques described herein relate to a circularly polarized antenna, wherein the at least one filter unit includes a first filter unit and a second filter unit, the first filter unit being electrically connected to a first connection circuit between the first coupling branch and the reference ground of the circuit board, and the second filter unit being electrically connected to a second connection circuit between the second coupling branch and the reference ground of the circuit board.

In some implementations, the first filter unit is configured for filtering out the resonant signal at the second target frequency, and the second filter unit is configured for filtering out the resonant signal at the first target frequency.

In some implementations, the self-resonant frequency of the radiator is less than the first target frequency and greater than the second target frequency.

In some implementations, the first target frequency includes an L1 frequency band of a GPS satellite positioning system, and the second target frequency includes an L5 frequency band of the GPS satellite positioning system.

In some implementations, the techniques described herein relate to a circularly polarized antenna, wherein the first coupling branch includes a coupling portion electromagnetically coupled with the annular radiator, a grounding portion connected to a first end of the coupling portion, and a feeding portion connected to a second end of the coupling portion, and wherein the first end is arranged at the feeding portion, and the second end is arranged at the grounding portion.

In some aspects, the techniques described herein relate to a wearable device including the circularly polarized antenna.

In some implementations, the wearable device includes a housing, at least a portion of the housing forming the annular radiator.

In some implementations, the housing includes a middle frame made of non-metallic material and a bezel made of metallic material, the bezel being arranged on one end surface of the middle frame, and at least a portion of the bezel forming the annular radiator.

In some implementations, a recess is provided on the end surface of the middle frame in contact with the bezel, and the coupling excitation unit is arranged in the recess.

In some implementations, the techniques described herein relate to a wearable device, wherein the coupling excitation unit is arranged inside the middle frame.

In some aspects, the circularly polarized antenna of the present disclosure includes a circuit board, an annular radiator spaced from the circuit board, a coupling excitation unit and a first tuning element. The coupling excitation unit is arranged in proximity to the annular radiator and electromagnetically coupled thereto, including a first coupling branch with a first end electrically connected to the feeding portion of the circuit board and a second end connected to the reference ground of the circuit board via the first tuning element. The coupling excitation unit, the first tuning element and circuit board form an annular current loop.

In some implementations, since there is no direct electrical connection between the annular radiator and other electrical components, the design of the wearable device becomes more flexible. Additionally, grounding the coupling excitation unit via the first tuning element is applicable to both radiators having a relatively high self-resonant frequency (i.e., a relatively small effective physical size) and those with a relatively low self-resonant frequency (i.e., a relatively large effective physical size), thus enhancing the practicality and flexibility of antenna design.

In some implementations, the techniques described herein relate to a circularly polarized antenna, wherein the first tuning element includes at least one of an inductor or a capacitor.

In some implementations, the techniques described herein relate to a circularly polarized antenna, wherein the circularly polarized antenna is a satellite positioning antenna of the wearable device.

In some implementations, the first tuning element includes an inductor, such that the resonance frequency of the annular radiator is increased toward a target operating frequency.

In some implementations, the first tuning element includes a capacitor, such that the resonance frequency of the annular radiator is decreased toward a target operating frequency.

In some implementations, the coupling branch includes an arc-shaped structure, and a length of the coupling branch is defined by an angle extending between a feeding point and a grounding point around a center of the annular radiator, such that at least one of polarization direction or resonant frequency can be adjusted.

In some implementations, the at least one extension branch includes a first extension branch extending from the first end, wherein at least one of the first extension branch or the second extension branch is electrically connected to the reference ground of the circuit board via a second tuning element.

### BRIEF DESCRIPTION OF THE DRAWINGS

In order to more clearly illustrate the technical solutions in the specific embodiments of the present disclosure or in the related art, the accompanying drawings to be used in the description of the specific embodiments or the related art are briefly described below. Obviously, the drawings in the following description are illustrative of some embodiments of the present disclosure. For those of ordinary skill in the art, other drawings can be obtained without creative efforts.

FIG. 1A and FIG. 1B are schematic diagrams of structures of circularly polarized antennas in the related art.

FIG. 2 is a schematic diagram of an example structure of a circularly polarized antenna according to some embodiments of the present disclosure.

FIG. 3 is a schematic diagram of another example structure of the circularly polarized antenna according to some embodiments of the present disclosure.

FIG. 4 is a schematic diagram of an example structure of a wearable device according to some embodiments of the present disclosure.

FIG. 5 is a schematic diagram of axis ratio performance of the circularly polarized antenna according to some embodiments of the present disclosure.

FIG. 6 is another schematic diagram of the axis ratio performance of the circularly polarized antenna according to some embodiments of the present disclosure.

FIG. 7 is a schematic diagram of distributions of left-handed polarization region and right-handed polarization region of the circularly polarized antennas if a first tuning element is an inductor according to some embodiments of the present disclosure.

FIG. 8 is another schematic diagram of the axis ratio performance of the circularly polarized antenna in some embodiments of the present disclosure.

FIG. 9 is another schematic diagram of the axis ratio performance of the circularly polarized antenna in some embodiments of the present disclosure.

FIG. 10A is a schematic diagram of an example right-handed transmission line circuit as well as corresponding electromagnetic field and transmission direction.

FIG. 10B is a schematic diagram of an example left-handed transmission line circuit as well as corresponding electromagnetic field and transmission direction.

FIG. 11 is an example schematic diagram of a circularly polarized antenna according to some embodiments of the present disclosure.

FIG. 12 is another example schematic diagram of the axis ratio performance of the circularly polarized antenna according to some embodiments of the present disclosure.

FIG. 13 is another example schematic diagram of the axis ratio performance of the circularly polarized antenna according to some embodiments of the present disclosure.

FIG. 14 is an example schematic diagram of distributions of the left-handed region and the right-handed region for the circularly polarized antennas if the first tuning element is a capacitor in some embodiments of the present disclosure.

FIGS. 15A, 15B, 15C and 15D are schematic diagrams of example structures of the circularly polarized antenna according to some other embodiments of the present disclosure.

FIG. 16 is another example schematic diagram of the axis ratio performance of the circularly polarized antenna according to some embodiments of the present disclosure.

FIG. 17A and FIG. 17B are schematic diagrams of example structures of the circularly polarized antenna according to some other embodiments of the present disclosure.

FIG. 18 is a schematic diagram of another example structure of the circularly polarized antenna according to some other embodiments of the present disclosure.

FIG. 19 is a schematic diagram of performance comparison between the circularly polarized antenna provided by embodiments of the present disclosure and the circularly polarized antenna in the related art.

FIG. 20 is a schematic diagram of current distributions of the circularly polarized antenna provided by embodiments of the present disclosure and the circularly polarized antenna in the related art.

FIG. 21 is a curve graph showing variation of the axial ratio with frequency of a circularly polarized antenna in the related art under different parameters.

FIG. 22 is a curve graph showing variation of the axial ratio with frequency for another circularly polarized antenna in the related art under different parameters.

FIG. 23 is a schematic diagram of current distributions of a circularly polarized antenna in the related art.

### DETAILED DESCRIPTION

Embodiments of the present disclosure will be clearly and completely described below in conjunction with the accompanying drawings. Obviously, the described embodiments are some, but not all, of the embodiments of the present disclosure. Based on the embodiments in the present disclosure, all other embodiments obtained by those of ordinary skill in the art without making creative effort fall within the protection scope of the present disclosure. In addition, the technical features involved in the different embodiments of the present disclosure described below can be combined with each other as long as they do not conflict with each other.

A main advantage of a circularly polarized antenna over a linearly polarized antenna is that, when antenna efficiency is comparable, the intensity of the satellite signals received by the ground devices can be increased by about 3 dB (i.e., doubled), and at the same time, the satellite positioning system's ability to suppress rain and fog interference and resist multipath reflections can be enhanced, thereby providing more accurate positioning information and motion trajectories.

However, smart wearable devices are often limited by their sizes or industrial designs, which makes it difficult to realize circularly polarized antennas. Instead, linearly polarized antennas are commonly used, which leads to poor satellite positioning performance of the smart wearable devices, especially in situations with multipath reflections caused by tree shades or tall buildings. Therefore, from an antenna design perspective, designing a circularly polarized satellite positioning antenna suitable for smart wearable devices remains a pressing challenge in the industry.

In the present disclosure, the self-resonant frequency of the circular antenna radiator refers to the inherent resonance frequency of the antenna radiator, which is determined by the effective size or effective perimeter of the antenna radiator. Specifically, this self-resonant frequency refers to the resonant frequency of the antenna system without applying a tuning element.

Generally, a larger effective size or effective circumference of the annular radiator corresponds to a lower self-resonant frequency, and a smaller effective size or effective circumference of the annular radiator corresponds to a higher self-resonant frequency. The effective size of a radiator is not only related to its physical size, but also related to the components around the radiator. For example, the screen assembly (including the glass cover, and the display and touch components, etc.) has a great influence on the effective size of the radiator. In addition, due to presence of the coupling effects, the shape of the circuit board and a distance from the radiator to the circuit board also affect the effective size of the radiator, which can be understood by those skilled in the art, and will not be repeated in the present disclosure.

In some existing solutions, the circularly polarized antennas of the wearable devices are realized by directly feeding the annular radiators. Taking a smart watch as an example of a wearable device, in some cases, the metal middle frame of the smart watch can be used as the annular radiator of the circularly polarized antenna. In some other cases, such as when the middle frame of the smart watch is made of a non-metal material, a metal bezel is often provided around the periphery of the watch screen. The metal bezel is often in the shape of a ring, and can be used to realize the annular radiator of the circularly polarized antenna. However, when the smart watch is provided with a metal bezel, due to the limited internal space of the smart watch, in order to realize a direct electrical connection between the circuit board and the annular radiator—while also taking into account the size of the screen display area and the design of the waterproof structure—the structure and size of the smart watch are inevitably affected, complicating the overall design.

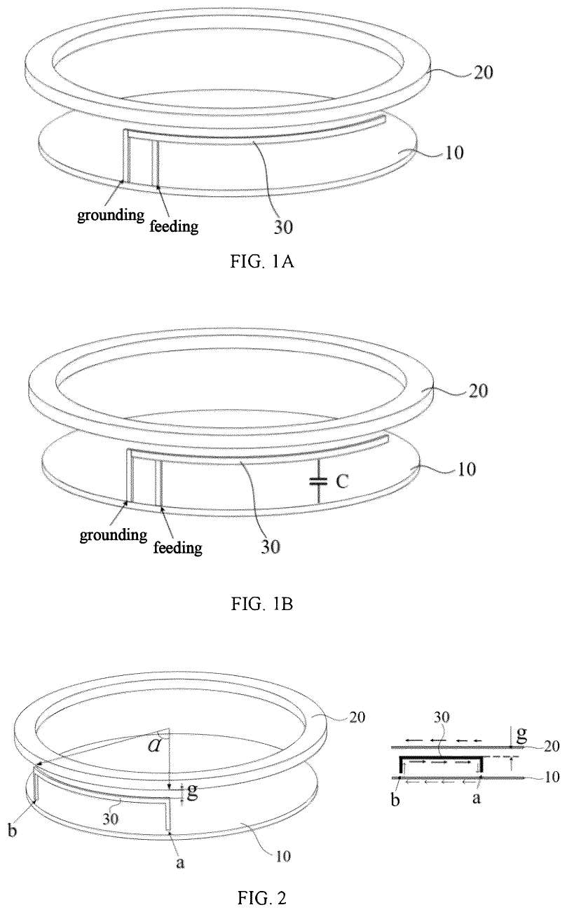

In some solutions, such as the ones shown in FIG. 1A and FIG. 1B, the circularly polarized antenna is realized by coupling an annular radiator to an inverted-F coupling branch. However, there is no direct electrical connection between the circuit board and the annular radiator. Instead, a coupling connection is established.

As shown in FIG. 1A, a circuit board 10 is spaced apart from a metal ring 20 without a direct electrical connection therebetween. An inverted-F excitation unit coupled to the metal ring 20 is formed between the circuit board 10 and the metal ring 20 via an inverted-F coupling branch. Through the coupling between a coupling branch of the inverted-F excitation unit and the metal ring 20, a circularly polarized antenna is formed by generating a circular current in the metal ring 20. In addition, in another structure shown in FIG. 1B of the scheme, a capacitor C, which is directly connected to the ground, is provided at an end of the inverted-F excitation unit, so as to increase the flexibility in antenna design.

When realizing the circularly polarized antenna, the above scheme not only requires an adjustment of a branch length of the coupling branch, but also a necessary adjustment of a coupling interval between the inverted-F coupling branch and the metal ring 20, resulting in high structural complexity and difficulty for implementing the circularly polarized antenna.

More importantly, further research conducted by the inventors of the present disclosure revealed that, the circularly polarized antenna realized by coupling the inverted-F coupling branch with the metal ring as shown in FIGS. 1A and 1B is only applicable to limited cases where the self-resonant frequency of the metal ring 20 is greater than a target operating frequency. Therefore, when the self-resonant frequency of the metal ring 20 is lower than the target operating frequency, the desired circularly polarized antenna cannot be achieved by this scheme.

For instance, taking the target operating frequency being the L1 frequency band (centered at 1.575 GHz) of the GPS satellite positioning system as an example, when the self-resonant frequency F₀ of the metal ring 20 is greater than 1.575 GHZ, e.g., F₀=1.65 GHZ, the coupling scheme shown in FIGS. 1A and 1B can be utilized to increase the effective electrical length of the metal ring and to reduce the resonant frequency of the metal ring from 1.65 GHz to 1.575 GHz, thus realizing a GPS circularly polarized antenna. However, when the self-resonant frequency F₀ of the metal ring 20 is 1.4 GHz, which is lower than 1.575 GHz, it becomes infeasible: after the coupling scheme shown in FIGS. 1A and 1B is utilized to increase the effective electrical length of the metal ring, the resonant frequency of the metal ring would be lower than 1.4 GHz.

Furthermore, in the scheme shown in FIG. 1B, even if the capacitor C directly connecting to the ground is added on the basis of the inverted-F coupling branch, it is still essentially adjusting the degree of freedom of the antenna design based on the inverted-F coupling branch, which does not ameliorate the defects due to the coupling of the inverted-F coupling branch. Moreover, research conducted by the inventors found that the presence of capacitor C further deteriorates the circular polarization performance, which will be explained below in the present disclosure.

In summary, the schemes illustrated in FIGS. 1A and 1B result in circularly polarized antennas that are structurally complex and challenging to design. Moreover, they are only suitable for scenarios in which the effective size of the metal ring is relatively small, thereby limiting their applicability to all sizes of wearable devices. For example, in case of smartwatches—which vary in size depending on their intended use—it is necessary to design circularly polarized antennas that can accommodate both small-sized and large-sized watches.

Implementations of the present disclosure provide a circularly polarized antenna and a wearable device having the circularly polarized antenna, aiming at realizing the circularly polarized antenna without directly electrically connecting (e.g., directly feeding) the annular radiator. Moreover, the resonant frequency of the circularly polarized antenna can be flexibly adjusted to improve the design applicability. Particularly importantly, the embodiments of the present disclosure are applicable to wearable devices with metal rings of different sizes.

In some embodiments, the circularly polarized antenna provided by the embodiments of the present disclosure can be used to implement a positioning antenna for an electronic device, such as a GPS antenna. In some other embodiments, the circularly polarized antenna can be used to realize a short-range communication antenna of an electronic device, such as a WIFI antenna, a Bluetooth antenna, etc., or to realize a cellular communication antenna of an electronic device, such as an LTE antenna, etc., which is not limited by the embodiments of the present disclosure.

A circularly polarized antenna in the embodiments of the present disclosure includes a circuit board, an annular radiator, and a coupling excitation unit.

In some embodiments, the circuit board may be a printed circuit board (PCB). The circuit board may be served as the main board of the electronic device, and various circuit modules may be provided on the circuit board to realize corresponding functions. Alternatively, the circuit board may be a flexible printed circuit board (FPCB). Alternatively, the circuit board may be of other types, such as a combination of a PCB and an FPCB, etc., which is not limited by the present disclosure.

In the antenna system, a radio frequency (RF) feed circuit is provided on the circuit board. The RF feed circuit may be, for example, an RF integrated circuit (IC) chip. The RF feed circuit serves as an excitation source of the antenna, and is configured to feed the radiator. The circuit board further includes a reference ground. The reference ground refers to the ground (GND) of the antenna system, which serves as a zero potential plane of the antenna system, and is typically a copper layer of the circuit board. The term “grounding” as described hereinafter in the present disclosure refers to electrically connecting to the reference ground of the circuit board.

In the embodiments of the present disclosure, the radiator of the circularly polarized antenna has an annular structure, which serves as at least a part of the housing of the wearable device. Taking a smart watch as an example of the wearable device, in some cases, the middle frame of the smart watch is made of metal material, and the annular metal middle frame is taken as the annular radiator. In some other cases, the front of the smart watch has a decorative bezel made of metal material, and the decorative bezel is taken as the annular radiator. In yet another case, other portions of the housing of the smart watch may be taken as the annular radiator, which is not limited by the present disclosure.

It can be understood that, the embodiments of the present disclosure do not set limitations on the specific shape of the annular radiator. The annular radiator may be, for example, a circular ring structure, a rectangular ring structure, a rhombic ring structure, an elliptical ring structure, or an annular structure of other shapes, which will not be elaborated herein.

In the embodiments of the present disclosure, there is direct electrical connection between the radiator and the circuit board, and the radiator is spaced apart from the circuit board. In an example, the radiator is disposed around the periphery of the circuit board, forming an annular gap between the radiator and the circuit board. In another example, the radiator may be disposed above or below the circuit board with a certain distance therebetween. The present disclosure does not set any limitation herein.

The coupling excitation unit is arranged in proximity to the radiator and electromagnetically coupled to the radiator. The coupling excitation unit is disposed between the circuit board and the radiator. In the embodiments of the present disclosure, the coupling excitation unit includes a coupling branch that is electromagnetically coupled to the radiator. Electromagnetic coupling refers to a phenomenon where two components do not directly contact each other, but a change in the current or voltage of one component induces a corresponding change in the current or voltage of the other component. The role of the electromagnetic coupling in the antenna system is to transfer electromagnetic energy from one component to the other.

In the embodiments of the present disclosure, the coupling branch of the coupling excitation unit is electrically connected to the circuit board or main board of the electronic device. A first end of the coupling branch is electrically connected to a feeding portion of the circuit board, which may be the aforementioned RF feed circuit, and the RF feed circuit feeds the coupling branch. A second end of the coupling branch is connected to the reference ground of the circuit board through a first tuning element, forming a grounding current path. In this way, the feeding portion of the circuit board (e.g., the RF feed circuit), the coupling branch, the first tuning element, and the reference ground of the circuit board form a closed circular current loop.

The coupling branch is disposed in proximity to the annular radiator without directly contacting the annular radiator, forming an electromagnetic coupling effect. A current distribution in the coupling branch with a certain length or arc length induces the current in the annular radiator to rotate, causing the radiator to generate circularly polarized resonance and thus realizing a circularly polarized antenna with an annular structure. Correspondingly, the coupling excitation unit herein is referred to as a loop excitation unit, which can be understood by those skilled in the art based on the related patent applications described above, and will not be illustrated furthermore in the embodiments of the present disclosure.

In the embodiments of the present disclosure, the second end of the coupling branch is not directly grounded, but electrically connected to the reference ground via the first tuning element. The first tuning element includes at least one of a capacitor or an inductor. The first tuning element is configured for adjusting a resonance frequency of the radiator, thereby tuning the resonance frequency of the radiator to a target operating frequency.

In the embodiments of the present disclosure, an effective circumference of the annular radiator is defined as a wavelength λ, and a frequency corresponding to the wavelength λ is the self-resonant frequency F₀ of the annular radiator.

It can be understood, if the self-resonant frequency of the radiator is F₀, grounding via an inductor may reduce the effective electrical length of the radiator, and the tuned resonance frequency F of the radiator is greater than the self-resonant frequency F₀; while grounding via a capacitor may increase the effective electrical length of the radiator, and the tuned resonance frequency F of the radiator is less than the self-resonant frequency F₀.

In some embodiments of the present disclosure, the first tuning element may include an inductor, a capacitor, or a combination thereof. Alternatively, the first tuning element may include other components capable of realizing adjustment of the resonance frequency spectrum. In the case that the second end of the coupling branch is grounded via an inductor, the effective electrical length of the radiator is reduced, and the final resonance frequency F of the radiator is greater than the self-resonant frequency F₀. In the case that the second end of the coupling branch is grounded via a capacitor, the effective electrical length of the radiator is increased, and the final resonance frequency F of the radiator is less than the self-resonant frequency F₀.

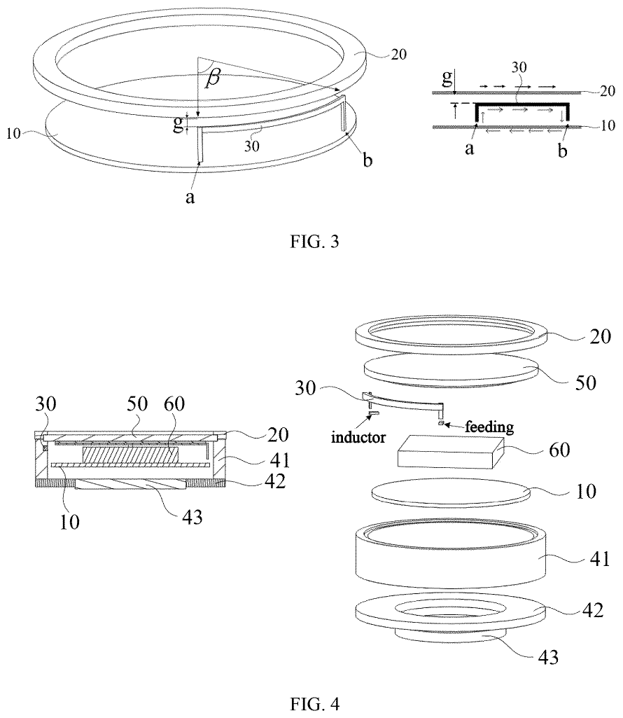

FIGS. 2 and 3 respectively illustrate an example structure of the circularly polarized antenna according to some embodiments of the present disclosure. In the example shown in FIG. 2, the coupling branch 30 is grounded via an inductor, and in the example shown in FIG. 3, the coupling branch 30 is grounded via a capacitor. The implementations of the circularly polarized antenna provided by the embodiments of the present disclosure will be described below in conjunction with FIGS. 2 and 3, respectively.

As shown in FIGS. 2 and 3, in the embodiments of the present disclosure, the circularly polarized antenna includes a circuit board 10 and an annular radiator 20 arranged at an interval from the circuit board 10. A coupling excitation unit is arranged in proximity to the annular radiator 20 and electromagnetically coupled to the annular radiator 20, and includes a coupling branch 30 that is coupled to the annular radiator 20. In this example, a spacing between the coupling branch 30 and the annular radiator 20 is g.

In the examples shown in FIGS. 2 and 3, the coupling excitation unit is disposed between the circuit board 10 and the annular radiator 20. The first end of the coupling branch 30 is electrically connected to the RF feeding circuit of the circuit board 10, and the second end of the coupling branch 30 is electrically connected to the reference ground of the circuit board 10 via an inductor or a capacitor. For the convenience of description, a connection point between the first end of the coupling branch 30 and the RF feeding circuit of the circuit board 10 is defined as a feeding point a hereinafter, and a connection point between the second end of the coupling branch 30 and the reference ground of the circuit board 10 is defined as a grounding point b.

In the example shown in FIG. 2, at the grounding point b, the coupling branch 30 is electrically connected to the reference ground via an inductor (not shown). It can be understood that, in an AC circuit, the current through an inductor lags behind the voltage. Therefore, in the example shown in FIG. 2, the current in the coupling branch 30 flows from the grounding point b to the feeding point a, and the current direction in the coupling branch 30 is opposite to the inherent current direction in the annular radiator 20. The coupling and superposition of these two currents in opposite directions reduces the local current magnitude and decreases the effective electrical length of the annular radiator 20. As a result, the resonance frequency of the annular radiator 20 shifts to a higher frequency, and the resonance frequency F of the radiator 20 is greater than the self-resonance frequency F₀.

In the example shown in FIG. 3, at the grounding point b, the coupling branch 30 is electrically connected to the reference ground via a capacitor (not shown). It can be understood that, in an AC circuit, the current though a capacitor leads the voltage. Therefore, in the example shown in FIG. 3, the current in the coupling branch 30 flows from the feeding point a to the grounding point b, and the current direction in the coupling branch 30 is the same as the inherent current direction in the annular radiator 20. The coupling and superposition of these two currents in the same direction increases the local current magnitude and the effective electrical length of the annular radiator 20. Therefore, the resonance frequency of the radiator 20 shifts to a lower frequency, and the resonance frequency F of the radiator 20 is less than the self-resonance frequency F₀.

In the embodiments of the present disclosure, the coupling branch 30 is grounded via the first tuning element. In the case that an inductor is taken as the first tuning element, it can be applied to the annular radiator 20 with a relatively large size, and in the case that a capacitor is taken as the first tuning element, it can be applied to the annular radiator 20 with a relatively small size, making the design of the circularly polarized antenna more flexible and practical.

Taking the L1 frequency band of the GPS satellite positioning system centered at 1.575 GHz as an example. In some cases, if a physical length of the annular radiator 20 is relatively large and its self-resonance frequency F₀ is 1.4 GHz, the structure shown in FIG. 2 may be adopted, in which the coupling branch 30 in the coupling excitation unit is grounded via an inductor, so as to reduce the effective electrical length of the annular radiator 20 and increase the resonance frequency from 1.4 GHz to 1.575 GHz to realize a GPS L1 circularly polarized antenna.

In some other examples, such as in the cases that the annular radiator 20 has a relatively small physical length and its self-resonant frequency F₀ is 1.65 GHZ, the structure shown in FIG. 3 may be employed, where the coupling branch 30 of the coupling excitation unit is grounded via a capacitor, so as to increase the effective electrical length of the annular radiator 20, which lowers the resonance frequency from 1.65 GHz to 1.575 GHz to realize a GPS L1 circularly polarized antenna.

In some circular smart watches, such as watches with a dial or case diameter of approximately 46 mm, the self-resonant frequency of the circular radiator 20 may be less than 1.575 GHz; while for watches with a dial or case diameter of approximately 42 mm, the self-resonant frequency of the circular radiator 20 may exceed 1.575 GHz. It can be seen from the above description that, the technical solution disclosed in these embodiments is applicable to smart watches with various dial or case diameters.

It can be appreciated that, in the embodiments of the present disclosure, an advantage lies in the absence of direct electrical connection between the annular radiator and other electrical components, thereby offering greater design flexibility for wearable devices. For instance, in a smart watch, the annular radiator may be formed by a metallic middle frame of the smart watch. Since the metallic middle frame does not directly connect electrically to the circuit board, electrical connection structures on the metallic middle frame can be omitted, thereby reducing both hardware costs and assembly difficulty. Additionally, for the internal design of highly stacked wearable devices, implementations according to the present disclosure no longer require reserving space for the electrical connection structures, thus enabling more flexible spatial stacking designs. As another example, the annular radiator may be implemented using the metallic bezel of the smartwatch, following similar principles as described above and further detailed in the sections below.

Another advantage lies in that, the coupling branch of the coupling excitation unit is grounded via the first tuning element, which allows the antenna design to accommodate radiators with both relatively high self-resonant frequencies (corresponding to smaller effective physical lengths) and relatively low self-resonant frequencies (corresponding to larger effective physical lengths), thus enhancing the practicality and flexibility of the antenna design.

In the following embodiments of this disclosure, taking smart watches as an example of the wearable devices, the structure and implementations of the circularly polarized antenna and the wearable device will be described for cases where the first tuning element is an inductor or a capacitor, respectively.

FIG. 4 illustrates a cross-sectional view and an exploded view (i.e., a diagram showing the components in a disassembled state for illustrative purposes) of an example smart watch according to some embodiments of the present disclosure. As shown in FIG. 4, the smart watch in this example includes a middle frame 41 and a bottom case 42. The middle frame 41 is arranged on the side of the smart watch, and the bottom case 42 is connected to the lower end surface of the middle frame 41, such that the middle frame 41 and the bottom case 42 together form the housing structure of the watch.

In some embodiments, a heart rate boss 43, in the form of a raised structural component, is further provided in the middle area of the bottom case 42. The area where the heart rate boss 43 is located is adapted to provide a heart rate detection apparatus, so as to enable a heart rate detection when the watch is worn by a user. This is understandable to those skilled in the art, and will not be elaborated herein.

The smart watch further includes a circuit board 10 and a battery assembly 60, which are disposed within an accommodation space formed by the middle frame 41 and the bottom case 42. The circuit board 10 serves as the main board of the smart watch and integrates various circuit components. The battery assembly 60 may be mounted on the circuit board 10, or on another circuit board.

Continuing with FIG. 4, the smart watch in this example further includes a screen assembly 50 and a bezel 20. The screen assembly 50 refers to a display device covering the upper surface of the housing of the smart watch. The screen assembly 50 is mounted on the upper end surface of the middle frame 41. The screen assembly 50 may be any suitable type of display device, such as an LCD (Liquid Crystal Display), an OLED (Organic Light-Emitting Diode) or the like, which is not limited by the present disclosure.

The bezel 20 is an annular structure made of metallic material. The bezel 20 is disposed around the outer edge of the screen assembly 50. The metallic bezel 20 serves two primary roles. On one hand, it provides decorative features for the watch. For example, time scales may be added to the bezel 20 as watch indicators. For another example, various scale markings may be arranged on the bezel 20 for additional functions of the watch. The metallic finish of the bezel 20 also enhances the aesthetic appearance of the watch. On the other hand, the bezel 20 conceals the black edge area of the screen assembly 50 where no display is projected, significantly improving the visual quality and user experience.

The metallic bezel 20 may be taken as the annular radiator 20 of the aforementioned circularly polarized antenna. For consistency of description, the bezel 20 is hereinafter referred to as the annular radiator 20 for example. As shown in FIGS. 2 and 3, the coupling excitation unit in this example includes a coupling branch 30. The first end of the coupling branch 30 is connected to the RF feed circuit of the circuit board 10 and is served as the feeding end, and the second end of the coupling branch 30 is connected to the reference ground of the circuit board through a first tuning element and is served as the grounding end.

The following describes the implementations of a GPS L1 circularly polarized antenna by the embodiments of the present disclosure, taking the first tuning element as an inductor or a capacitor, respectively. In this case, the target operating frequency of the circularly polarized antenna is 1.575 GHz.

In some embodiments, as shown in FIG. 4, the target operating frequency of the circularly polarized antenna is 1.575 GHz of the GPS L1 band. In an example of the present disclosure, the self-resonant frequency F₀ of the annular radiator 20 is 1.52 GHz, which is lower than the target operating frequency of 1.575 GHz. That is, the original effective electrical size of the annular radiator 20 is relatively large. In this case, the first tuning element may include an inductor, and the coupling branch 30 is grounded via the inductor to reduce the effective electrical length of the annular radiator 20, such that the resonance frequency F of the radiator 20 is greater than the self-resonant frequency F₀.

Additionally, in the examples shown in FIGS. 2 and 3, the coupling branch 30 has an arc-shaped structure, and the length of the coupling branch 30 is represented by a first angle α or a second angle β. For instance, in FIG. 2, the feeding point a is located at the 6 o'clock position of the watch. A first line connects the center of the annular radiator 20 to the feeding point a, and a second line connects the center of the annular radiator 20 to the grounding point b. A first angle α is defined as an angle around the center of the annular radiator formed by rotating clockwise from the first line to the second line. In FIG. 3, the feeding point a is also at the 6 o'clock position, and a second angle β is defined as an angle around the center of the annular radiator formed by rotating counterclockwise from the first line to the second line.

It can be understood that, a larger first angle α or second angle β indicates a longer length (or arc length) of the coupling branch 30, and vice versa. Therefore, the length of the coupling branch 30 is hereinafter represented by the first angle α or second angle β in the present disclosure.

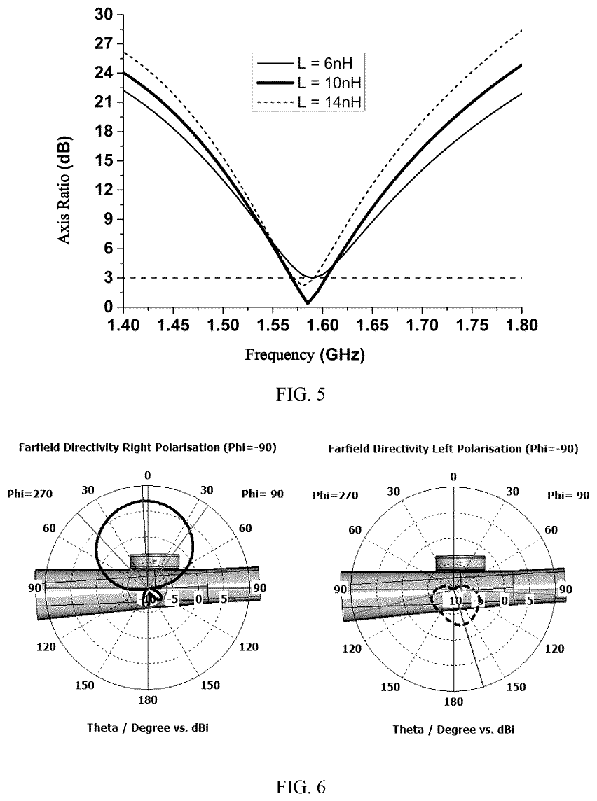

FIG. 5 illustrates curves of axial ratio of the circularly polarized antenna versus inductance value L of the inductor when the smart watch shown in FIG. 4 is worn on the wrist and the first angle α is 70°. FIG. 6 shows the left-handed and right-handed radiation patterns of the circularly polarized antenna in the case that the inductance value L is 10 nH shown in FIG. 5.

The axial ratio is a critical parameter characterizing the performance of a circularly polarized antenna. The axial ratio is defined as a magnitude ratio of two orthogonal electric field components of a circularly polarized wave. A smaller axial ratio indicates better circular polarization performance, while a larger axial ratio indicates poorer performance. In the embodiments of the present disclosure, a criterion for the performance of the circularly polarized antenna is that the axial ratio should be less than 3 dB. Additionally, a frequency corresponding to the optimal axial ratio is defined as an optimal axial ratio frequency.

It can be seen from FIG. 5 that, in the case that the first angle α is 70° and the inductance value L is 10 nH, the optimal axial ratio frequency of the circularly polarized antenna matches the central frequency of the GPS L1 band, 1.575 GHz. Since GPS satellites typically employ right-handed circularly polarized (RHCP) antenna while transmitting to the ground, the circularly polarized antenna of the wearable device may also be designed as an RHCP antenna. FIG. 6 demonstrates that the right-handed component of the circularly polarized antenna of the smart watch is significantly stronger than the left-handed component thereof. This confirms that the right-handed circularly polarized antenna formed by using the coupling excitation unit in the embodiments fully satisfies the design requirements for a GPS L1 circularly polarized antenna.

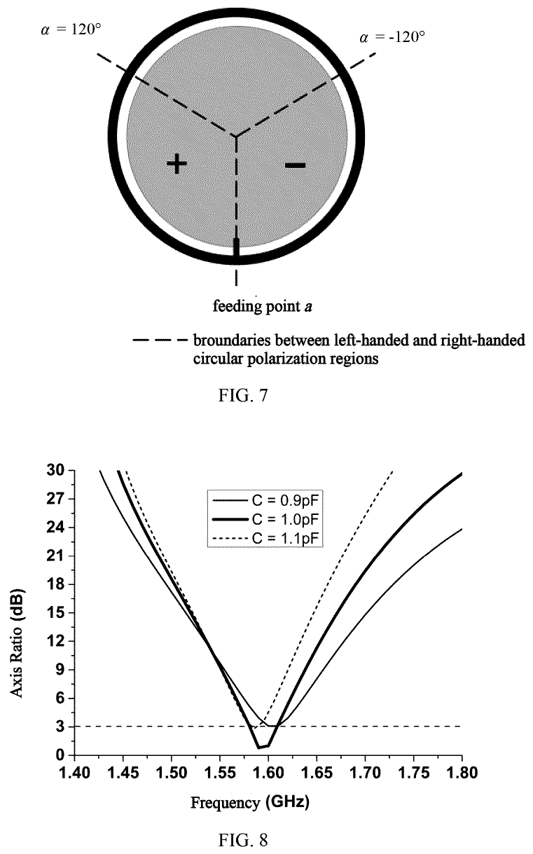

Additionally, as shown in FIG. 7, the circularly polarized antenna exhibits right-handed circular polarization in the case that the first angle α is within the range of 0° to 120° (denoted by “+” in FIG. 7), and the circularly polarized antenna exhibits left-handed circular polarization in the case that the first angle α is within the range of −120° to 0° (denoted by “−” in FIG. 7). The case that the first angle α is within the range of 120° to 240° is usually infeasible in smart watches due to internal structural constraints, and thus is not discussed herein.

Furthermore, in the case that the first angle α is less than 90°, a shift magnitude of the optimal axial ratio frequency toward higher frequency is proportional to the first angle α, and reaches a maximum value when the first angle α is 90°. In the case that the first angle α is greater than 90° but less than 120°, a shift magnitude of the optimal axial ratio frequency toward higher frequency is inversely proportional to the first angle α. It should be noted that, right-handed circular polarization may be realized in the case that the coupling branch 30 is directly grounded (i.e., the inductance value L is 0 nH) while the first angle α is around 120°.

It can be understood that, the above-mentioned rules apply to the case where the circuit board 10 is a circular circuit board and the spacing g is a particular value. Those skilled in the art can derive similar rules for the cases with non-circular or irregular circuit board 10 and different values of the spacing g, which are not further elaborated herein. Furthermore, a shift magnitude of the optimal axial ratio frequency toward higher frequency is proportional to a coupling strength between the coupling excitation unit and the metallic bezel. Therefore, it is necessary to increase the coupling strength to achieve a larger frequency shift magnitude. An approach to enhance the coupling strength is to reduce the spacing g between the coupling excitation unit and the metallic bezel. However, continuously reducing the spacing g is quite difficult due to structural limitations of the smart watch. In the present disclosure, the inductor is incorporated in the excitation loop, increasing the design freedom for the circularly polarized antenna, and significantly alleviating the stringent requirements on the spacing in the related art.

In some other embodiments, the first tuning element is a capacitor, i.e., the coupling branch 30 is grounded via a capacitor. As mentioned above, grounding via a capacitor can increase the effective electrical length of the annular radiator 20. Therefore, for the annular radiator 20 with a relatively small length, the resonance frequency F is adjusted from the self-resonance frequency F₀ to a lower frequency. For the structure of the smart watch in which the coupling branch is grounded via a capacitor, it can be understood and fully implemented by those skilled in the art based on FIG. 4, and thus is not repeatedly illustrated herein.

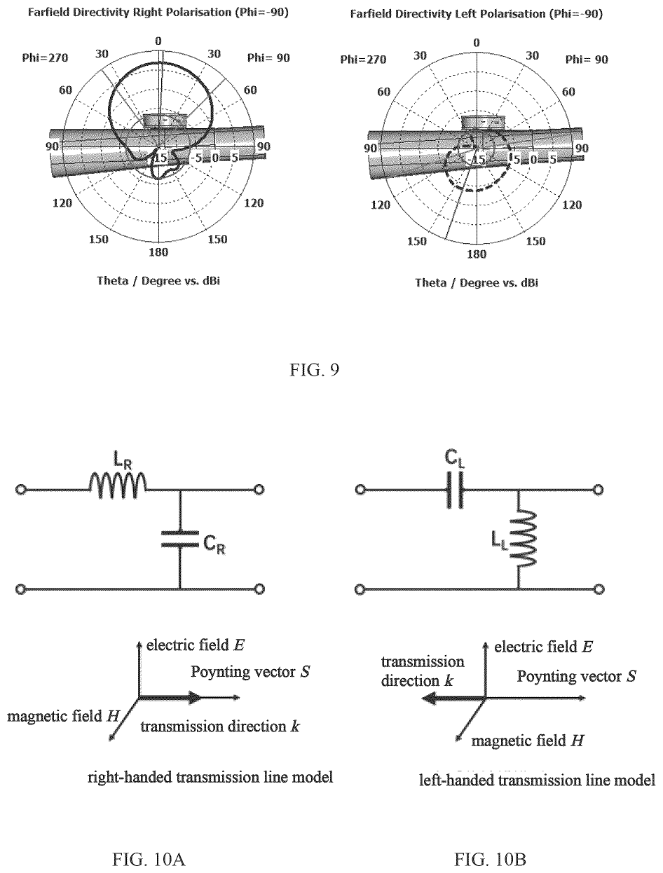

FIG. 8 shows curves of the axial ratio of the circularly polarized antenna versus the capacitance value C of the capacitor when the smart watch is worn on the wrist and the second angle β is 40°. FIG. 9 shows the left-handed and right-handed radiation patterns of the circularly polarized antenna in the case that the capacitance value C is 1.0 pF shown in FIG. 8.

It can be seen from FIG. 8 that, in the case that the second angle β is 40° and the capacitance value C is 1.0 pF, the optimal axial ratio frequency of the circularly polarized antenna is 1.582 GHz, which is very close to the center frequency of the GPS L1 band, 1.575 GHz. It can be seen from FIG. 9 that, the right-handed component of the circularly polarized antenna of the smart watch is much larger than its left-handed component. This demonstrates that, in the embodiments of this disclosure, the right-handed circular polarization formed by using the coupling excitation unit can fully satisfy the design requirements of the circularly polarized antenna in the GPS L1 band.

It is worth noting that, in the embodiments of the present disclosure, in the case that the coupling excitation unit is grounded via a capacitor, the interaction between the coupling excitation unit and the annular radiator generates the characteristics of a composite right/left handed (CRLH) transmission line. The characteristic causes the circularly polarized antenna to switch between left-handed and right-handed polarization. In other words, in the case that the coupling excitation unit is grounded via a capacitor, the polarization direction of the circularly polarized antenna changes in a more complicated manner, thus improving the design flexibility of the circularly polarized antenna, which will be described in detail below.

To facilitate understanding of the physical characteristics and operations of right-handed and left-handed transmission lines, FIGS. 10A and 10B illustrate equivalent circuits, corresponding electromagnetic fields, and transmission directions of ideal right-handed and left-handed transmission lines, respectively.

As shown in FIGS. 10A and 10B, from a circuit perspective, the right-handed transmission line is composed of an equivalent series inductance (LR) and an equivalent parallel capacitance (CR), while the left-handed transmission line is composed of an equivalent series capacitance (CL) and an equivalent parallel inductance (LL).

It can be seen from FIG. 10A that, in the right-handed transmission line model, a transmission direction k aligns with the direction of the Poynting vector S, i.e., the electric field E, the magnetic field H, and the transmission direction k follow the right-handed rule, hence it is referred to as the right-handed transmission line. Conversely, it can be seen from FIG. 10B that, in the left-handed transmission line model, the transmission direction k opposes the Poynting vector S, and the electric field E, the magnetic field H, and the transmission direction k follow the left-handed rule, thus it is referred to as the left-handed transmission line. The right-handed and left-handed transmission lines result in different current flow directions. The left-handed transmission line causes current to flow in a direction opposite to that caused by the right-handed transmission line, and flip of the current introduces a phase reversal that switches the circular polarization of the antenna from right-handed (or left-handed) to left-handed (or right-handed). In the case that characteristics of both the left-handed and right-handed transmission lines coexist in a single transmission line, it is referred to as a CRLH transmission line.

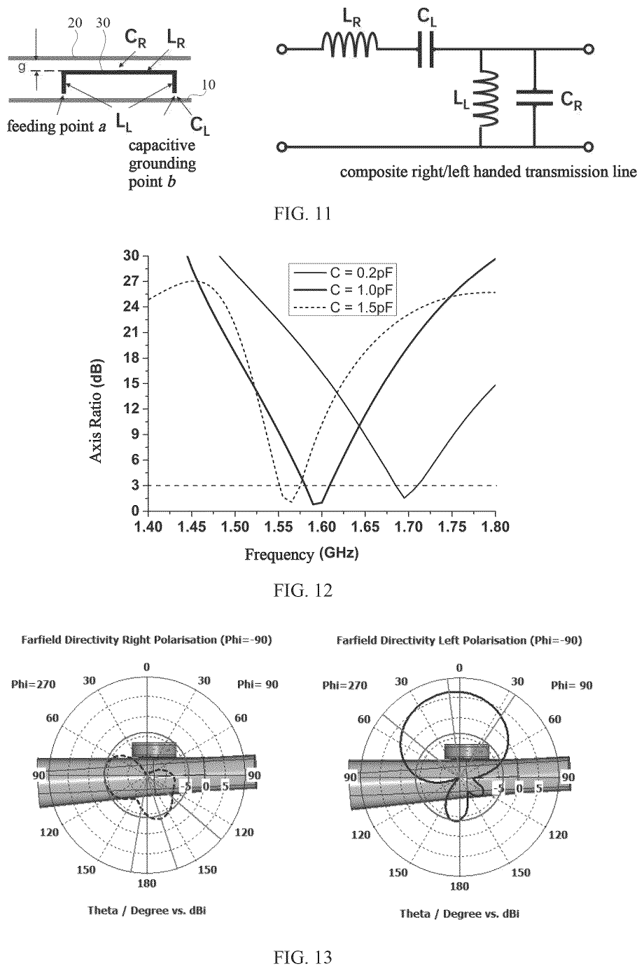

FIG. 11 illustrates a correspondence between the circularly polarized antenna grounded via a capacitor and the CRLH transmission line in the embodiments of the present disclosure. As shown in FIG. 11, an equivalent series inductance (LR) of the right-handed transmission line is generated by the coupling branch 30, and an equivalent parallel capacitance (CR) arises from the coupling between the coupling branch 30 and the annular radiator 20. An equivalent parallel inductance (LL) of the left-handed transmission line is generated by the feeding portion and the grounding portion of the coupling branch 30, while an equivalent series capacitance (CL) is provided by the capacitor (not shown). Thus, in these embodiments, the capacitively grounded circularly polarized antenna (i.e., circularly polarized antenna grounded via a capacitor) exhibits characteristics of both left-handed and right-handed transmission lines, embodying the properties of a CRLH transmission line. Therefore, in the case that a position of the capacitor is not changed, adjusting the capacitance value of the capacitor may enable switching between right-handed and left-handed circular polarization.

It is to be noted that, for the inductively grounded circularly polarized antenna (i.e., circularly polarized antenna grounded via an inductor), the circuit structure lacks the equivalent series capacitance (CL) required to excite characteristics of the left-handed transmission line. As a result, in contrast to the capacitively grounded circularly polarized antenna, the inductively grounded circularly polarized antenna exhibit characteristics of only the right-handed transmission line rather than the characteristics of the CRLH transmission line.

In the embodiments of the present disclosure, for the capacitively grounded circularly polarized antenna that exhibits characteristics of the CRLH transmission line, adjusting the capacitance value may yield circularly polarized antennas with different rotation directions. FIG. 12 shows curves of the axial ratio versus capacitance value for the case that the second angle β is 40°. As shown in FIG. 12, in the cases that the capacitance values are 0.2 pF, 1.0 pF, and 1.5 pF respectively, a circularly polarized antenna with an axial ratio less than 3 dB in the GPS L1 band is realized, with corresponding optimal axial ratio frequencies of 1.695 GHz, 1.582 GHz, and 1.565 GHz, respectively.

Although these axial ratios under the above-mentioned capacitance values can satisfy the requirements of a circularly polarized antenna, as the capacitance value changes, the rotation direction of the circular polarization switches between left-handed and right-handed polarization. For instance, when the capacitance value C is 1.0 pF, its corresponding optimal axial ratio frequency is 1.582 GHz. Referring to FIG. 9 for the rotation direction of circular polarization, it can be seen that, in this case, the circularly polarized antenna is a right-handed circularly polarized antenna. Furthermore, in the case that the optimal axial ratio frequency is 1.695 GHz (i.e., C=0.2 pF), the circularly polarized antenna is also the desired right-handed circularly polarized antenna. While in the case that the capacitance value C is 1.5 pF, its corresponding optimal axial ratio frequency is 1.565 GHz. Referring to FIG. 13 for the radiation pattern of the circularly polarized antenna, it can be seen that, in this case, the left-handed component is much larger than the right-handed component, which means that the circularly polarized antenna becomes a left-handed circularly polarized antenna.

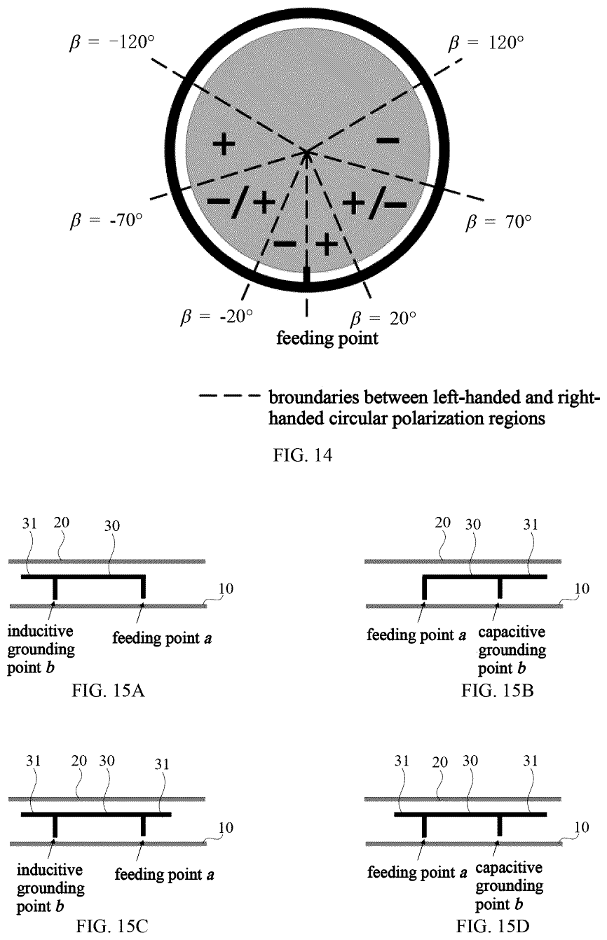

It can be seen from the above that, in a capacitively grounded circularly polarized antenna, the switch between left-handed and right-handed polarization of the circularly polarized antenna can be achieved by adjusting the capacitance value. Moreover, the switch from right-handed to left-handed polarization can be realized only when the capacitance value is greater than a certain threshold. In the embodiments of the present disclosure, the left-handed polarization region and the right-handed polarization region of the capacitively grounded circularly polarized antenna are shown in FIG. 14.

In FIG. 14, the right-handed polarization region is represented by “+”, and the left-handed polarization region is represented by “−”. The CRLH regions are represented by “−/+” and “+/−”. In these regions, a right-handed or left-handed circularly polarized antenna may be realized according to the capacitance value. Specifically, the region represented by the symbol “−/+” indicates that, as the capacitance value increases, the originally left-handed polarization region gradually changes to a right-handed polarization region. Conversely, the region represented by the symbol “+/−” indicates that, as the capacitance value increases, the originally right-handed polarization region gradually changes to a left-handed polarization region. Therefore, in the capacitively grounded circularly polarized antenna, in the case that the second angle β is between 0 and 20°, the circularly polarized antenna is a right-handed circularly polarized antenna. In the case that the second angle β is between 20° and 70°, the circularly polarized antenna has the characteristics of a CRLH transmission line, i.e., a switch between right-handed and left-handed polarization may be achieved by adjusting the capacitance value. In the case that the second angle β is between 70° and 120°, the circularly polarized antenna is a left-handed circularly polarized antenna. In the case that the second angle β is between −120° and −70°, the circularly polarized antenna is a right-handed circularly polarized antenna. In the case that the second angle β is between −70° and −20°, the circularly polarized antenna has the characteristics of a CRLH transmission line, i.e., a switch between left-handed and right-handed polarization may be achieved by adjusting the capacitance value. In the case that the second angle β is between −20° and 0°, the circularly polarized antenna is a left-handed circularly polarized antenna. In addition, in the present disclosure, the cases where the absolute value of the second angle β is greater than 120° are not taken into consideration. The reason is that, as mentioned above, due to the internal structure limitations of the smart watches, the coupling excitation unit with an absolute angle greater than 120° is generally not recommended for use.

It can be understood that, the above-mentioned rules apply to the case where the circuit board 10 is a circular circuit board and the spacing g is a particular value. Those skilled in the art can derive similar rules for the cases with non-circular or irregular circuit board 10 and different values of the spacing g, which are not further elaborated herein. Furthermore, a shift magnitude of the optimal axial ratio frequency is proportional to a coupling strength between the coupling excitation unit and the metallic bezel. Therefore, it is necessary to increase the coupling strength to achieve a larger frequency shift magnitude. An approach to enhance the coupling strength is to reduce the spacing g between the coupling excitation unit and the metallic bezel. However, continuously reducing the spacing g can be quite difficult due to structural limitations of the smart watch. In the present disclosure, the inductor is incorporated in the excitation loop, increasing the design freedom for the circularly polarized antenna, and significantly alleviating the stringent requirements on the spacing in the related art.

It can be seen from the above that, in the embodiments of the present disclosure, grounding the coupling excitation unit via an inductor or capacitor enables compatibility with radiators having both relatively high self-resonant frequencies (corresponding to relatively small effective physical sizes) and relatively low self-resonant frequencies (corresponding to relatively large effective physical sizes), enhancing the practicality and flexibility of antenna design. Furthermore, for the capacitively grounded circularly polarized antenna, adjusting the capacitance value within the CRLH region allows switching between left-handed and right-handed polarization, thus further improving the flexibility of the circularly polarized antenna in the present disclosure.

In some embodiments, the coupling branch 30 includes a coupling portion electromagnetically coupled to the annular radiator, a grounding portion connected to one end of the coupling portion, and a feeding portion connected to the other end of the coupling portion, where the first end is disposed on the feeding portion, and the second end is disposed on the grounding portion.

In the above-described embodiments, both the feeding portion and the grounding portion of the coupling branch 30 are located at the ends of the coupling branch 30, i.e., the first end of the coupling branch 30 is connected to the feeding portion of the circuit board 10, and the second end is connected to the ground. In some other embodiments, the coupling excitation unit further includes an extension branch 31, extending outward from the end of the coupling portion of the coupling branch 30.

For instance, in FIGS. 15A and 15B, the extension branch 31 extends from one end of the coupling portion of the coupling branch 30, and in FIGS. 15C and 15D, extension branches 31 extend from two ends of the coupling portion of the coupling branch 30. The extension branch 31 lengthens the coupling branch 30, enabling fine-tuning of the resonant frequency of the circularly polarized antenna. The electromagnetic coupling between the extended branch and the antenna radiator 20 enhances the electromagnetic coupling between the coupling excitation unit and the antenna radiator, thus effectively shifting the resonant frequency to a lower frequency. Thus, based on the resonant frequency tuned by the first tuning element, the extension branch provides additional tuning on the tuned resonant frequency. The extension branch provides a smaller tuning magnitude than that by the first tuning element, so as to achieve the target operating frequency. For instance, in the inductively grounded coupling excitation unit, an additional coupling capacitance is produced between the extension branch 31 and the annular radiator 20, and the coupling capacitance slightly reduces the pulling effect on the axial ratio frequency caused by the inductive grounding. Conversely, in the capacitively grounded coupling excitation unit, an additional coupling capacitance is also produced between the extension branch 31 and the annular radiator 20, and the coupling capacitance slightly enhances the pulling effect on the axial ratio frequency of the capacitive grounding. Additionally, the extension branch 31 may allow integration of more antenna frequency bands in the circularly polarized antenna, such as the Bluetooth and Wi-Fi band centered at 2.4 GHz or the like.

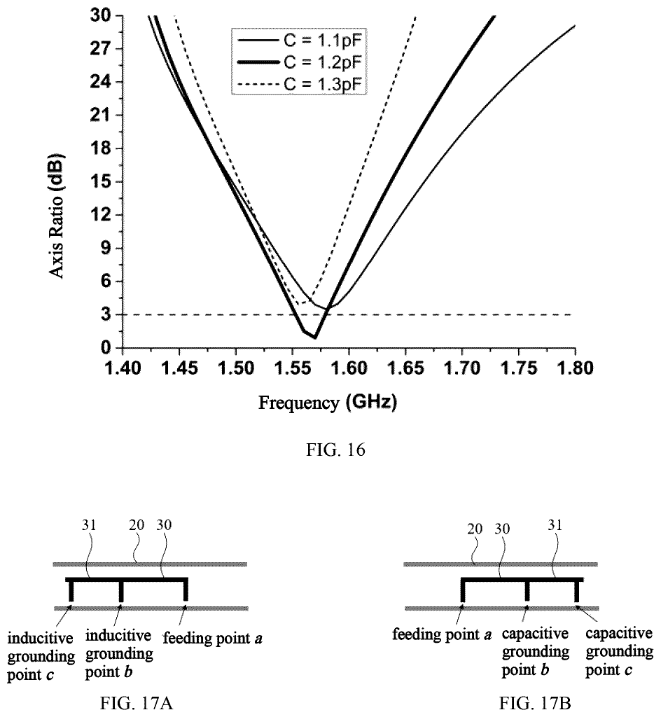

FIG. 16 illustrates variation curves of the axial ratio of the circularly polarized antenna shown in FIG. 15B under different capacitance values, where the second angle β is 40°, and an end of the extension branch 31 away from the coupling branch 30 is at the position where the second angle β is 60°. Comparing FIG. 8 and FIG. 16, it can be seen that, the optimal axial ratio frequency in FIG. 16 is 1.57 GHz, while it is 1.582 GHz in FIG. 8, which demonstrates that introducing the extension branch 31 lowers the resonant frequency of the circularly polarized antenna from 1.582 GHz to 1.57 GHz, and fully illustrates that fine-tuning of the resonant frequency can be realized by the extension branch 31, thereby further enhancing the design flexibility of the circularly polarized antenna.

In the embodiments shown in FIGS. 17A and 17B, on the basis the circularly polarized antenna shown in FIGS. 15A and 15B, the end of the extension branch 31 away from the coupling branch 30 is also grounded via a second tuning element. The second tuning element includes an inductor, or a capacitor, or both a capacitor and an inductor. Specifically, in FIGS. 17A and 17B, the extension branch 31 is grounded via an inductor or a capacitor at a grounding point c. In these embodiments, grounding the extension branch 31 via an inductor or a capacitor can further fine-tune the resonant frequency of the circularly polarized antenna. In this case, the feeding point a and grounding point b serve as the primary tuning structures for adjusting the operating frequency of the circularly polarized antenna, while the extension branch 31 and the grounding point c form an auxiliary tuning structure for fine-tuning the operating frequency of the circularly polarized antenna, which can further adjust the resonant frequency of the circularly polarized antenna and improve the design accuracy and flexibility of the circularly polarized antenna. In particular, it should be noted that, in some antenna structures, for the coupling excitation unit grounded via an inductor, the circularly polarized antenna may be achieved by using an inductor with a quite small inductance value (such as an inductor with an inductance value close to or equal to 0 nH). In addition, although FIGS. 17A and 17B only show the situation where the extension branch 31 is at the grounding end of the coupling excitation unit, the extension branch 31 may be configured similar to the situation shown in FIGS. 15C and 15D, i.e., the extension branch 31 is provided at both ends of the coupling excitation unit, which can be understood by those skilled in the art and will not be repeated in the present disclosure.

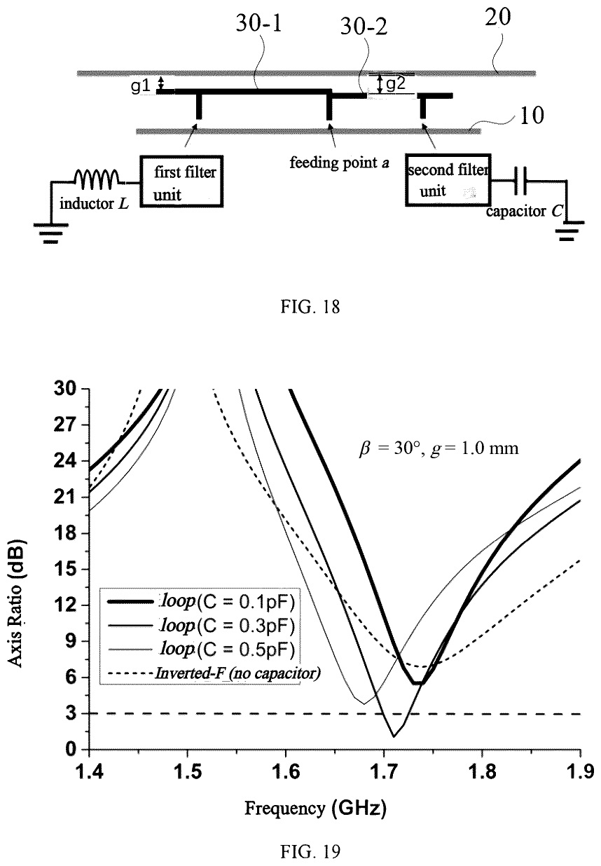

In the embodiment shown in FIG. 18, the coupling branch 30 includes a plurality of coupling branches, such as a first coupling branch 30-1 and a second coupling branch 30-2. The first coupling branch 30-1 and the second coupling branch 30-2 share a same feeding point. In other words, both the first coupling branch 30-1 and the second coupling branch 30-2 are connected to the RF feeding circuit of the circuit board 10 at the feeding point a. A spacing between the first coupling branch 30-1 and the annular radiator 20 is g1, and a spacing between the second coupling branch 30-2 and the radiator 20 is g2, where g1 and g2 may be the same or different from each other.

An end of the first coupling branch 30-1 is grounded via the first tuning element. In the example shown in FIG. 18, the first tuning element is an inductor L. An end of the second coupling branch 30-2 is grounded via a third tuning element. In the example shown in FIG. 18, the third tuning element is a capacitor C. In some implementations, a filter unit is provided on the grounding circuit of at least one of the first coupling branch 30-1 or the second coupling branch 30-2, and is configured to filter out signals of a preset frequency band.

In some examples, as shown in FIG. 18, a first filter unit is provided on the grounding circuit of the first coupling branch 30-1, and a second filter unit is provided on the grounding circuit of the second coupling branch 30-2.

The first filter unit is configured to filter out the resonant signal generated by the second coupling branch 30-2, and the second filter unit is configured to filter out the resonant signal generated by the first coupling branch 30-1. Thus, in the embodiments of the present disclosure, the signals produced by the first and second coupling branches do not interfere with each other, and a dual-frequency circularly polarized signal is generated by using a singular annular radiator 20.

In an example, single-frequency GPS refers to the GPS L1 band (i.e., the frequency band centered at 1.575 GHz), while dual-frequency GPS refers to both the GPS L1 band centered at 1.575 GHz and the GPS L5 band centered at 1.176 GHz. Compared to single-frequency GPS, the dual-frequency GPS has a higher positioning accuracy.

In the embodiments of the present disclosure, taking the dual-frequency GPS as an example, the self-resonant frequency F₀ of the annular radiator 20 is between 1.176 GHz and 1.575 GHz. The first coupling branch 30-1 adjusts the resonant frequency from the self-resonant frequency F₀ to generate the GPS L1 band, while the second coupling branch 30-2 adjusts the resonant frequency from the self-resonant frequency F₀ to generate the GPS L5 band. Since the presence of the first and second filter units, the signals in the GPS L1 band and the GPS L5 band do not interfere with each other, thus realizing a dual-frequency GPS circularly polarized antenna.

In some embodiments, a dual-frequency GPS circularly polarized antenna may be achieved by providing only one filter unit. For instance, if the GPS L1 band is obtained via inductive grounding and the GPS L5 band is obtained via capacitive and inductive grounding, a corresponding filter unit may be provided only at the capacitive grounding point to achieve the dual-frequency GPS circularly polarized antenna.

In some embodiments, the dual-frequency circularly polarized antenna includes at least one filter unit. For example, a filter unit may be provided only on the grounding circuit of the first coupling branch 30-1 or only on the grounding circuit of the second coupling branch 30-2, both of them may implement the aforementioned dual-frequency circularly polarized antenna, details of which are not repeated herein. For a detailed description of the dual-frequency circularly polarized antenna, those skilled in the art may refer to the inventor's prior Chinese patent application CN114846696A, the entire content of which is incorporated by reference.

As can be seen from the above, in the embodiments of the present disclosure, since there is no direct electrical connection between the annular radiator 20 and other electrical components, the design of the wearable device becomes more flexible. Additionally, grounding the coupling branch 30 of the coupling excitation unit via the first tuning element is applicable to radiators of relatively high self-resonant frequencies (i.e., relatively small effective physical sizes) or relatively low self-resonant frequencies (i.e., relatively large effective physical sizes), enhancing the practicality and flexibility of antenna design.

Furthermore, for capacitively grounded circularly polarized antennas, adjusting the capacitance value within the CRLH region allows switching between left-handed and right-handed polarization, thus further improving the flexibility of the circularly polarized antenna in the present disclosure.

To further elaborate the advantages of the circularly polarized antenna of the present disclosure over the circularly polarized antenna based on the inverted-F excitation unit shown in FIGS. 1A and 1B, a detailed simulation comparison of the two schemes is provided below. To accomplish the comparison, a simplified antenna structure of the watch is used for simulation, which includes only essential components required for the antenna system: an annular radiator, a circuit board and corresponding coupling excitation unit.

FIG. 19 shows axial ratio curves of the circularly polarized antenna based on the loop excitation unit of the present disclosure and the inverted-F excitation unit of FIG. 1A, under conditions where the length of the coupling branch corresponds to a second angle β being 30° and the spacing g between the coupling branch and the annular radiator 20 is 1.0 mm. The inverted-F excitation unit is directly grounded without incorporating a capacitor in the grounding circuit.

As can be seen from FIG. 19, the antenna based on the inverted-F excitation unit fails to satisfy the circular polarization condition with an axial ratio less than 3 dB. In contrast, the loop excitation unit of the present disclosure allows highly effective adjustment of the axial ratio by tuning the capacitance value, and the optimal axial ratio is achieved in the case where the capacitance value C is 0.3 pF.

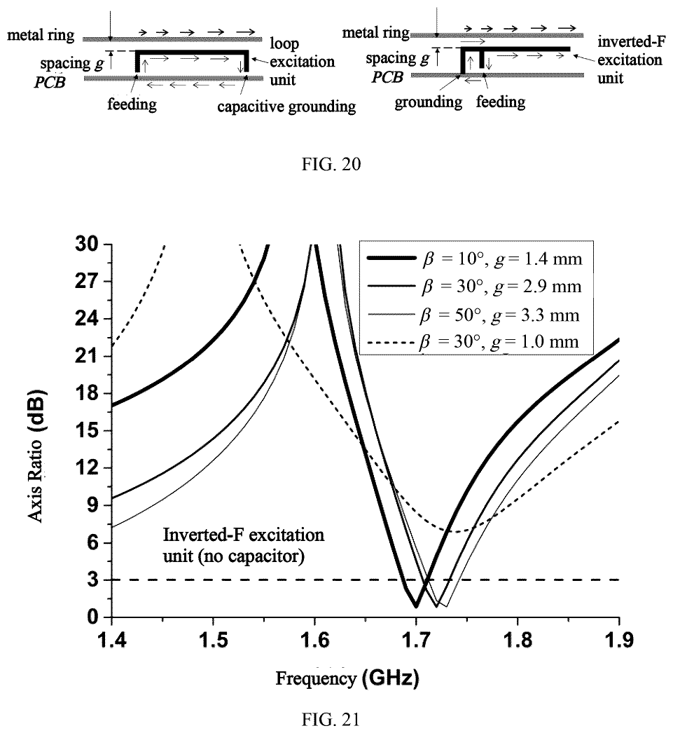

To further explain the reason for the above-mentioned results, FIG. 20 shows the current distribution curves for utilizing the loop excitation unit of the present disclosure and the inverted-F excitation unit shown in FIG. 1A. It can be seen from FIG. 20 that, on the coupling branch of the loop excitation unit of the present disclosure, the current is uniformly distributed at different positions. However, on the coupling branch of the inverted-F excitation unit, the current is non-uniformly distributed at different positions, and closer to the end of the IFA antenna corresponds to smaller current. The non-uniform current distribution on the coupling branch of the inverted-F excitation unit leads to a poor coupling effect. As a result, a circularly polarized antenna that satisfies the axial ratio requirement cannot be obtained when the spacing g is fixed. The uniform current distribution on the loop coupling branch in the embodiments of the present disclosure enhances the coupling effect. In addition, the existence of the grounding capacitor in the embodiments of the present disclosure further increases the degree of freedom for adjusting the axial ratio, thereby reducing the design difficulty of the circularly polarized antenna.

In the cases where the inverted-F excitation unit is utilized in the related art, in order to obtain a circularly polarized antenna that satisfies the axial ratio requirement, if the length of the coupling branch (i.e., the second angle β) is fixed, the spacing g between the coupling branch and the radiator should be adjusted. FIG. 21 shows corresponding spacing g for achieving the optimal axial ratio with different lengths of the coupling branch (i.e., different second angles β).

It can be seen from FIG. 21 that, if the second angle β is 30°, in order to adjust the axial ratio to meet the requirement of the circularly polarized antenna, the spacing g should be adjusted from the original 1.0 mm to 2.9 mm. It can also be seen from FIG. 21 that, in order to obtain the optimal axial ratio that satisfies the circularly polarized antenna, the spacing g needs to be adjusted to 1.4 mm and 3.3 mm for the cases where β is 10° and 50° respectively. To obtain a circularly polarized antenna that satisfies the requirements, it is necessary to adjust both the length of the coupling branch and the spacing between the coupling branch and the annular radiator, which undoubtedly increases the design difficulty of the antenna and has relatively high requirements for the space of the wearable device.

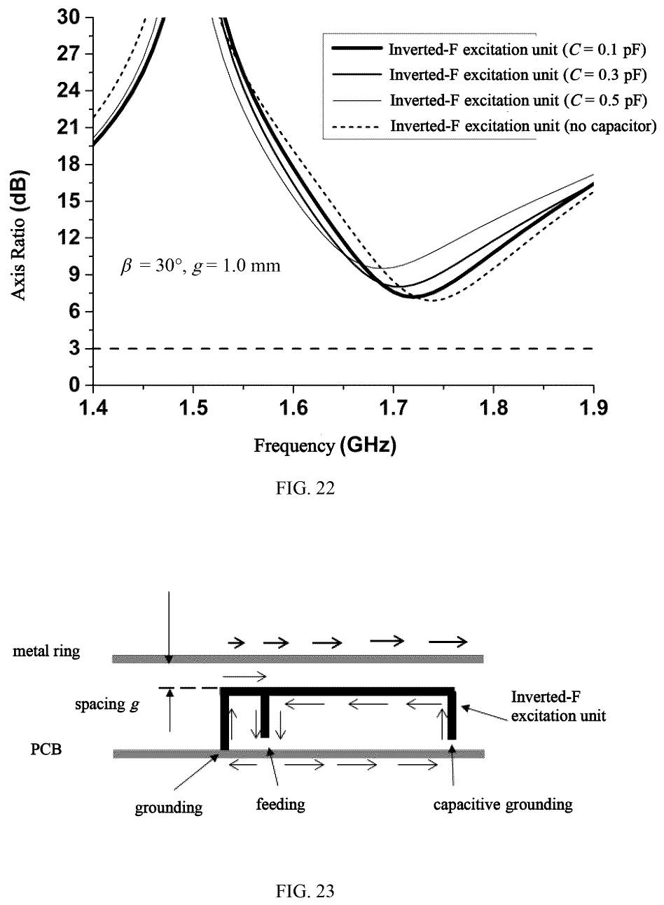

In addition, the inventors have found through research that, although a capacitor can be provided on the coupling branch of the inverted-F excitation unit, for example, as shown in FIG. 1B, the capacitor cannot positively affect the adjustment of the axial ratio of the antenna. To illustrate the above problem, FIG. 22 shows variation curves of the axial ratio of the antenna structure in FIG. 1B with different capacitance values. In addition, the axial ratio of the antenna structure without providing a capacitor on the coupling branch of the inverted-F excitation unit is also shown in FIG. 22.

It can be seen from FIG. 22 that, if a capacitor is provided on the coupling branch of the inverted-F excitation unit, compared to the case without the capacitor, the axial ratio of the antenna shifts away from 3 dB required by the circular polarization. This is due to the fact that, if an additional capacitor is provided on the coupling branch of the inverted-F excitation unit, as shown in FIG. 23, two current loops with opposite rotation directions are generated in the coupling branch. Specifically, although the current between the grounding point and the feeding point of the IFA antenna is clockwise, the current between the feeding point and the capacitor grounding point is counter-clockwise. The existence of the above-mentioned current loops in opposite directions results in that providing a grounding capacitor on the IFA coupling branch cannot positively affect the axial ratio of the antenna. Therefore, in the solution described in FIG. 1B, adding a grounding capacitor to the coupling branch of the inverted-F excitation unit not only fails to improve the circular polarization performance, but also further deteriorates the circular polarization performance.

In the embodiments of the present disclosure, the coupling excitation unit implemented as a loop excitation unit is grounded via the first tuning element, which can be applied to both radiators with a relatively large self-resonant frequency (corresponding to a relatively small effective physical size) and radiators with a relatively small self-resonant frequency (corresponding to a relatively large effective physical size), resulting in better practicability and flexibility for the antenna design. Moreover, compared to the solutions disclosed in FIGS. 1A and 1B, the present disclosure has better circular polarization performance and improves the antenna efficiency.

In the above-mentioned embodiments, the annular radiator 20 is implemented by using the bezel of the smart watch. In some other embodiments, the annular radiator 20 may be implemented by using the middle frame 41 of the smart watch, the implementations of which are similar to the foregoing, and can be understood by those skilled in the art by referring to the foregoing. The present disclosure will not repeat it herein.

The embodiments of the present disclosure further provide a wearable device, which includes the circularly polarized antenna according to any of the above-mentioned embodiments.

In some embodiments, the circularly polarized antenna may include one or more antennas. For example, the circularly polarized antenna may include a GPS antenna, and an operating frequency band of the GPS antenna may include, for example, the GPS L1 and L5 bands, thereby realizing a dual-frequency GPS antenna.

In some embodiments, the wearable device includes a housing, where at least a portion of the housing forms the annular radiator.

In some embodiments, the housing includes a middle frame made of non-metallic material and a bezel made of metallic material. The bezel is disposed on an end surface of the middle frame, and at least a portion of the bezel forms the annular radiator.

In some embodiments, a recess is provided on the end surface of the middle frame in contact with the bezel, and the coupling excitation unit is disposed within the recess.

In some embodiments, the coupling excitation unit is provided inside the middle frame.

In the embodiments of the present disclosure, there is no limitation on the type of the wearable device, which may be implemented as any suitable device, such as smart watches, smart bracelets, TWS (True Wireless Stereo) earphones, smart glasses, smart clothing, AR/VR headset, or the like, and the present disclosure is not limited thereto.

In some embodiments, the wearable device may be a smart watch as shown in FIG. 4. Referring to FIG. 4, the coupling branch 30 is embedded inside the middle frame 41. In an example, the middle frame 41 is injection molded with plastic material, and the coupling branch 30 may be integrated into the middle frame 41 during the injection molding process of the middle frame 41.

In some alternative embodiments, the coupling branch 30 may be disposed on an end surface of the middle frame 41. Referring to FIG. 4, a recess is formed on the end surface of the middle frame 41 that contacts the bezel 20, and the coupling branch 30 is placed in the recess to achieve a coupling connection with the bezel 20. This is readily understandable by those skilled in the art and will not be elaborated further herein.

As can be seen from the above, in the embodiments of the present disclosure, since there is no direct electrical connection between the annular radiator 20 and other electrical components, the design of the wearable device becomes more flexible. Additionally, grounding the coupling branch 30 of the coupling excitation unit via the first tuning element is applicable to radiators of relatively high self-resonant frequencies (i.e., relatively small effective physical sizes) or relatively low self-resonant frequencies (i.e., relatively large effective physical sizes), enhancing the practicality and flexibility of antenna design.

Furthermore, for capacitively grounded circularly polarized antennas, adjusting the capacitance value within the CRLH region allows switching between left-handed and right-handed polarization. For example, a right-handed circularly polarized antenna may be realized in a left-handed polarization region by adjusting the capacitance value, thereby further improving the flexibility of the circularly polarized antenna of the present antenna.

In the embodiments of this disclosure, since there is no direct electrical connection between the annular radiator and other electrical components, and the first coupling branch is grounded via the first tuning element, the antenna design provides improved practicality and flexibility.

It is apparent that the above embodiments are merely examples for clear illustration and are not intended to limit the implementations. Those of ordinary skill in the art can make various changes or modifications based on the above description. It is unnecessary and impractical to enumerate all possible embodiments herein, but any obvious variations or modifications directly derived therefrom shall fall in the protection scope of the present disclosure.

What is claimed is:

1. A circularly polarized antenna applied to a wearable device, comprising:
a circuit board,
an annular radiator arranged at a distance from the circuit board; and
a coupling excitation unit arranged in proximity to the annular radiator and electromagnetically coupled to the annular radiator, wherein
the coupling excitation unit comprises a first coupling branch, a first end of the first coupling branch being electrically connected to a feeding portion of the circuit board;
the coupling excitation unit further comprises a first tuning element, a first end of the first tuning element being electrically connected to a second end of the first coupling branch, a second end of the first tuning element being electrically connected to a reference ground of the circuit board, and the first tuning element being configured for tuning a resonant frequency of the circularly polarized antenna; and
an annular current loop is formed between the coupling excitation unit and the circuit board.

2. The circularly polarized antenna according to claim 1,
wherein the coupling excitation unit further comprises at least one extension branch extending outward from at least one of the first end or the second end of the first coupling branch, the at least one extension branch being configured for further tuning the resonant frequency of the circularly polarized antenna.

3. The circularly polarized antenna according to claim 2,
wherein the coupling excitation unit further comprises a second tuning element, the at least one extension branch being electrically connected to the reference ground of the circuit board via the second tuning element, and the second tuning element being configured for further tuning the resonant frequency of the circularly polarized antenna.

4. The circularly polarized antenna according to claim 1,
wherein the coupling excitation unit further comprises a second coupling branch and a third tuning element, a first end of the second coupling branch sharing a common feeding point with the first end of the first coupling branch, and a second end of the second coupling branch being electrically connected to the reference ground of the circuit board via the third tuning element.

5. The circularly polarized antenna according to claim 1,
wherein the coupling excitation unit further comprises a second coupling branch, the first coupling branch is configured for electromagnetically coupling with the annular radiator to generate a resonant signal at a first target frequency, and the second coupling branch is configured for electromagnetically coupling with the annular radiator to generate a resonant signal at a second target frequency; and
wherein the circularly polarized antenna further comprises at least one filter unit, the at least one filter unit being electrically connected to a connection circuit between at least one of the first coupling branch or the second coupling branch, and the reference ground of the circuit board.

6. The circularly polarized antenna according to claim 5,
wherein the at least one filter unit comprises a first filter unit and a second filter unit, the first filter unit being electrically connected to a first connection circuit between the first coupling branch and the reference ground of the circuit board, and the second filter unit being electrically connected to a second connection circuit between the second coupling branch and the reference ground of the circuit board; and
wherein the first filter unit is configured for filtering out the resonant signal at the second target frequency, and the second filter unit is configured for filtering out the resonant signal at the first target frequency.

7. The circularly polarized antenna according to claim 5,
wherein a self-resonant frequency of the annular radiator is less than the first target frequency and greater than the second target frequency.

8. The circularly polarized antenna according to claim 5,
wherein the first target frequency comprises an L1 frequency band of a GPS satellite positioning system, and the second target frequency comprises an L5 frequency band of the GPS satellite positioning system.

9. The circularly polarized antenna according to claim 1,
wherein the first coupling branch comprises a coupling portion electromagnetically coupled with the annular radiator, a grounding portion connected to a first end of the coupling portion, and a feeding portion connected to a second end of the coupling portion, and
wherein the first end is arranged at the feeding portion, and the second end is arranged at the grounding portion.

10. The circularly polarized antenna according to claim 1,
wherein the first tuning element comprises at least one of an inductor or a capacitor.

11. The circularly polarized antenna according to claim 1,
wherein the circularly polarized antenna is a satellite positioning antenna of the wearable device.

12. A wearable device, comprising:
the circularly polarized antenna according to claim 1; and
a housing, wherein at least a portion of the housing forms the annular radiator.

13. The wearable device according to claim 12,
wherein the housing comprises a middle frame made of non-metallic material and a bezel made of metallic material, the bezel being arranged on one end surface of the middle frame, and at least a portion of the bezel forming the annular radiator.

14. The wearable device according to claim 13,
wherein a recess is provided on the end surface of the middle frame in contact with the bezel, and the coupling excitation unit is arranged in the recess.

15. The wearable device according to claim 13,
wherein the coupling excitation unit is arranged inside the middle frame.

16. The circularly polarized antenna according to claim 1,
wherein the first tuning element comprises an inductor, such that the resonance frequency of the annular radiator is increased toward a target operating frequency.

17. The circularly polarized antenna according to claim 1,
wherein the first tuning element comprises a capacitor, such that the resonance frequency of the annular radiator is decreased toward a target operating frequency.

18. The circularly polarized antenna according to claim 1, wherein the coupling branch comprises an arc-shaped structure, and a length of the coupling branch is defined by an angle extending between a feeding point and a grounding point around a center of the annular radiator, such that at least one of polarization direction or resonant frequency can be adjusted.

19. The circularly polarized antenna according to claim 2,
wherein the at least one extension branch comprises a first extension branch extending from the first end of the first coupling branch and a second extension branch extending from the second end of the first coupling branch, the first and second extension branches being configured to lengthen the coupling branch to enable fine-tuning of the resonant frequency of the circularly polarized antenna.

20. The circularly polarized antenna according to claim 2,
wherein at least one of the first extension branch or the second extension branch is electrically connected to the reference ground of the circuit board via a second tuning element.
